(19) United States
(12) Patent Application Publication
(10) Pub. No.: US 2012/0062941 A1
(43) Pub. Date: Mar. 15, 2012

(54) Image forming apparatus

(75) Inventor: Kazuki Sasayama, Kanagawa (JP)

(73) Assignee: Ricoh Company, Ltd., Tokyo (JP)

(21) Appl. No.: 13/137,627

(22) Filed: Aug. 30, 2011

(30) Foreign Application Priority Data
Sep. 13, 2010 (JP) 2010-204143

(51) Int. Cl. G06K 15/02

(52) U.S. Cl. 358/1.15

(57) ABSTRACT

An image forming apparatus includes a plurality of drawing processing units that process one or more drawing instructions included in a display list. At least two of the plurality of drawing processing units have different attributes with respect to a first drawing instruction. The image forming apparatus further includes an analyzing unit that acquires the first drawing instruction by analyzing the display list; and an allocating unit that allocates at least the first drawing instruction acquired by the analyzing unit to a first one of the drawing processing units based on the attributes of the drawing processing units with respect to the first drawing instruction.

### BACKGROUND OF THE INVENTION

1. Field of the Invention

The present invention relates to image forming apparatuses.

2. Description of the Related Art

As a result of increases in resolution and speed of image forming apparatuses, the amount of image data processed by a drawing processing unit of an image forming apparatus has increased in recent years. In response, a technology has been proposed whereby one or more drawing processing units are optionally added to a printer controller of the image forming apparatus, so that the image data can be processed by a plurality of drawing processing units using a display list (see Patent Document 1, for example).

When a drawing processing unit is optionally added, the drawing processing unit may have different processing capacities for drawing with respect to a drawing instruction in the display list. FIG. 1 illustrates the difference in drawing processing capacity among a first drawing processing unit 251, a second drawing processing unit 252, and a third drawing processing unit 253 with respect to a drawing instruction. The first drawing processing unit 251 has a high processing capacity for drawing graphics. The second drawing processing unit 252 has a low processing capacity for drawing graphics. The third drawing processing unit 253 has a normal processing capacity for drawing graphics. FIG. 2 illustrates image data of bands 1 through 5. The “band” refers to a minimum unit of image data (raster image). One or more display lists may be generated for each band. The display list indicates (or includes) one or more drawing instructions (or commands) for generating image data.

As illustrated in FIG. 3, when the second drawing processing unit 252, in spite of its low processing capacity for drawing graphics, is used for processing a display list of band 5 (DL5) having a number of instructions for drawing graphics, a long process time is required. Thus, in the related art, the processing capacity of the individual drawing processing units is not taken into consideration.

### Patent Document 1: Japanese Laid-open Patent Publication No. 2007-237510

### SUMMARY OF THE INVENTION

In view of the foregoing, it is an object of the present invention to provide an image forming apparatus capable of achieving an improved processing efficiency when two or more drawing processing units having different attributes are present.

According to an aspect of the present invention, an image forming apparatus includes a plurality of drawing processing units configured to process one or more drawing instructions included in a display list, at least two of the plurality of drawing processing units having different attributes with respect to a first drawing instruction; an analyzing unit configured to acquire the first drawing instruction by analyzing the display list; and an allocating unit configured to allocate at least the first drawing instruction acquired by the analyzing unit to a first one of the drawing processing units based on the attributes of the at least two drawing processing units with respect to the first drawing instruction.

According to another aspect of the present invention, an image forming method for forming an image by using a plurality of drawing processing units configured to process one or more drawing instructions included in a display list, at least two of the plurality of drawing processing units having different attributes with respect to a first drawing instruction, includes an analyzing step of acquiring the first drawing instruction by analyzing the display list; and an allocating step of allocating at least the first drawing instruction acquired in the analyzing step to a first one of the drawing processing units based on the attributes of the at least two drawing processing units with respect to the first drawing instruction.

### BRIEF DESCRIPTION OF THE DRAWINGS

FIG. 1 illustrates an example of the processing capacity of various drawing processing units;

FIG. 2 illustrates bands of image data;

FIG. 3 illustrates processing of DLs (display lists) by drawing processing units according to the related art;

FIG. 4 is a hardware block diagram of an image forming apparatus according to an embodiment of the present invention;

FIG. 5 is a functional block diagram of the image forming apparatus;

FIG. 6 is a functional block diagram of an image processing unit of the image forming apparatus;

FIG. 7 illustrates a process of generating a display list according to the present embodiment;

FIG. 8 illustrates processing of DLs by the drawing processing unit according to the present embodiment;

FIG. 9 is a functional block diagram of a control unit of the image forming apparatus;

FIG. 10 is a flowchart of a process performed by the image forming apparatus;

FIG. 11 illustrates an example of attribute information;

FIG. 12 illustrates another example of the attribute information;

FIG. 13 illustrates an example of an analysis result obtained by an analyzing unit of the control unit;

FIG. 14 is a flowchart of a process according to another embodiment; and

FIG. 15 illustrates processing of DLs by the drawing processing units according to another embodiment.

### DETAILED DESCRIPTION OF THE PREFERRED EMBODIMENTS

Before describing the preferred embodiments, various terms are explained. An “image forming apparatus” may refer to a printer,' a facsimile machine, a copy machine, a plotter, or a multifunction peripheral. A “recording medium” may include a substrate, a sheet, a continuous paper, a thread, a fiber, leather, a metal, plastics, glass, wood, or ceramics. “Image formation” refers to the process of imparting an image of characters, figures, or patterns, for example, onto the recording medium, such as by causing droplets of an image forming liquid to land on the recording medium.

In the following description, the recording medium may be referred to as a “sheet”, image formation may involve “printing”, and an image desired by a user may be printed on a “printing sheet”. A display list may simply be referred to as a “DL”.

Referring now to the drawings, wherein like reference numerals designate identical or corresponding parts throughout the several views, embodiments of the invention are described.

### Embodiment 1

### <System Configuration>

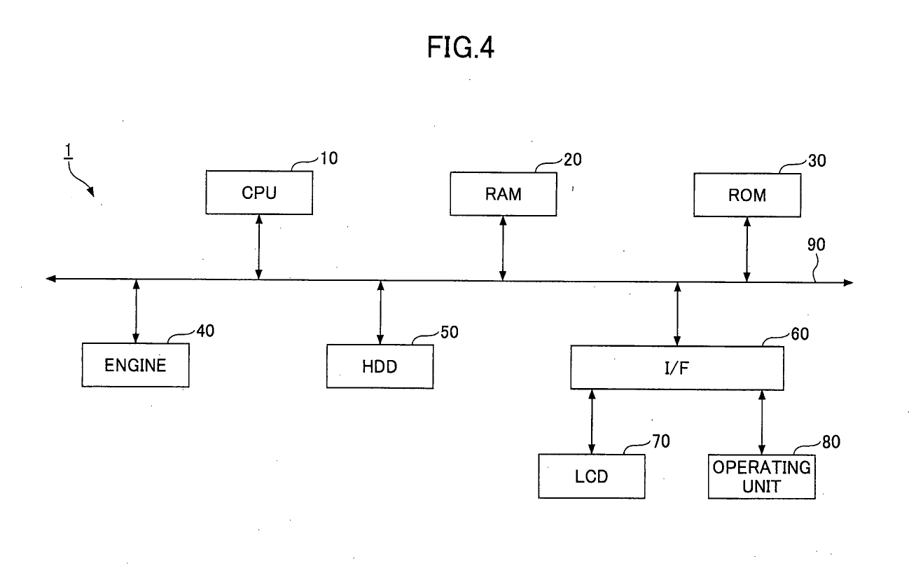

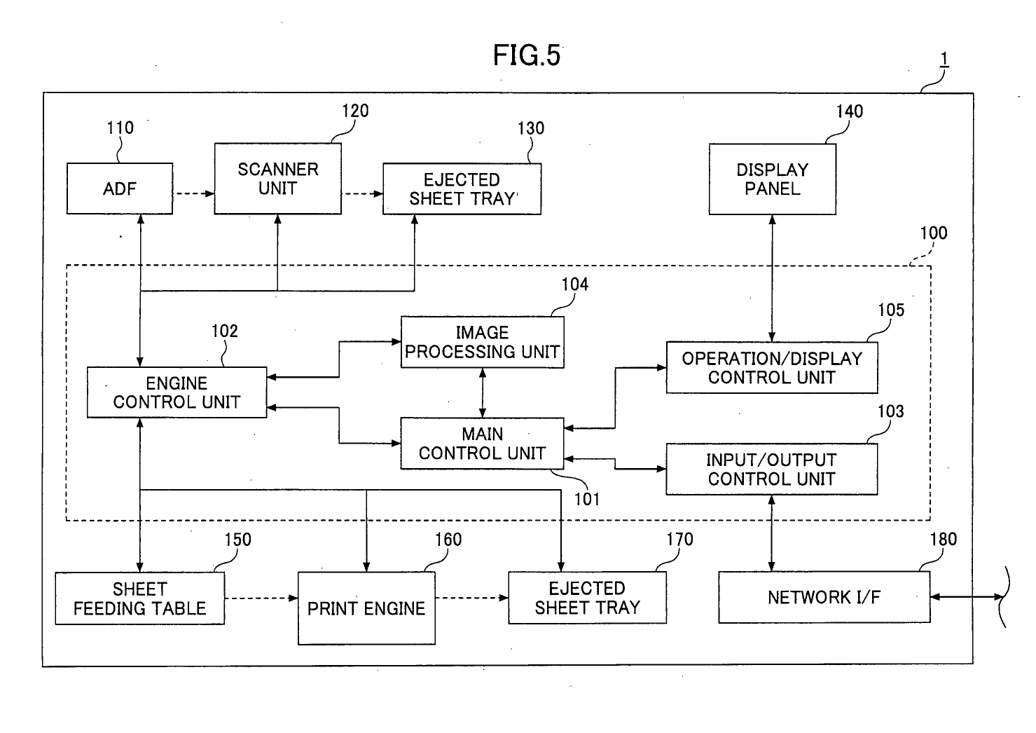

FIG. 4 is a hardware block diagram of an image forming apparatus 1 according to Embodiment 1. The image forming apparatus 1 includes a CPU (Central Processing Unit) 10, a RAM (Random Access Memory) 20, a ROM (Read Only Memory) 30, an engine 40, a HDD (Hard Disk Drive) 50, and an I/F (interface) 60, which are mutually connected via a bus 90. The I/F 60 is connected to an LCD (Liquid Crystal Display) 70 and an operating unit 80.

The CPU 10 controls the image forming apparatus 1 as a whole. The CPU 10 may include a multi-core CPU including a plurality of operating units, i.e., cores, that can operate independently from each other. The RAM 20 is a volatile storage medium capable of high-speed writing and reading of information. The RAM 20 may be used as a working area for processing of information by the CPU 10. The ROM 30 is a read-only non-volatile storage medium in which a program such as firmware may be stored. The engine 40 includes a mechanism that actually performs image formation in the image forming apparatus 1.

The HDD 50 is a non-volatile storage medium capable of reading and writing information. The HDD 50 may store an OS (Operating System), various control programs, and application programs. The I/F 60 may connect the bus 90 to various types of hardware and networks or control such connections. The LCD 70 provides a visual user interface allowing a user to recognize the state of the image forming apparatus 1. The operating unit 80 may include a keyboard and mouse providing a user interface allowing the user to input information into the image forming apparatus 1.

FIG. 5 is a functional block diagram of the image forming apparatus 1. The image forming apparatus 1 includes a controller 100, an ADF (Auto Document Feeder) 110, a scanner unit 120, ejected sheet trays 130 and 170, a display panel 140, a sheet-feeding table 150, a print engine 160, and a network I/F 180.

The controller 100 includes a main control unit 101, an engine control unit 102, an input/output control unit 103, an image processing unit 104, and an operations display control unit 105. In FIG. 5, electrical connections are indicated by solid lines, while flows of a sheet are indicated by broken lines.

The display panel 140 visually indicates a state of the image forming apparatus 1. The display panel 140 also enables the user to input information into the image forming apparatus 1. The network I/F 180 provides an interface for enabling the image forming apparatus 1 to communicate with other devices via a network.

The controller 100 includes a combination of software and hardware. Specifically, the controller 100 may include a software control unit and hardware such as an integrated circuit. The software control unit may be formed by loading a control program, such as firmware, stored in a non-volatile recording medium, such as the ROM 30, the HDD 50, or an optical disk, onto a volatile memory, such as the RAM 20, under the control of the CPU 10. The controller 100 controls the image forming apparatus 1 as a whole.

The main control unit 101 may control or supply instructions to the various units in the controller 100. The engine control unit 102 may control or drive the print engine 160 or the scanner unit 120. The input/output control unit 103 may control the input of signals or instructions entered via the network I/F 180 into the main control unit 101. The main control unit 101 may also control the input/output control unit 103 to access other devices via the network I/F 180.

The input/output control unit 103 receives a print job via the network I/F 180. The input/output control unit 103 transfers the print job to the main control unit 101. Upon reception of the print job, the main control unit 101 controls the image processing unit 104 to generate image data (raster image) based on print information contained in the print job.

The print information contained in the print job may include information that has been converted into a format recognizable by the image forming apparatus 1 by a printer driver installed in an information processing apparatus, such as a personal computer (PC). The print information may be in the format of PDL (Page Description Language), Postscript, PCL (Printer Command Language), or RPCS. In other words, the print information may include command information describing one or more commands for image formation or output.

In a page memory (which will be described later), image data (raster image) generated by a drawing processing unit is stored as will be described below. Based on the image data stored in the page memory, the print engine 160 forms an image on a sheet. The sheet is eventually ejected onto the ejected sheet tray 170.

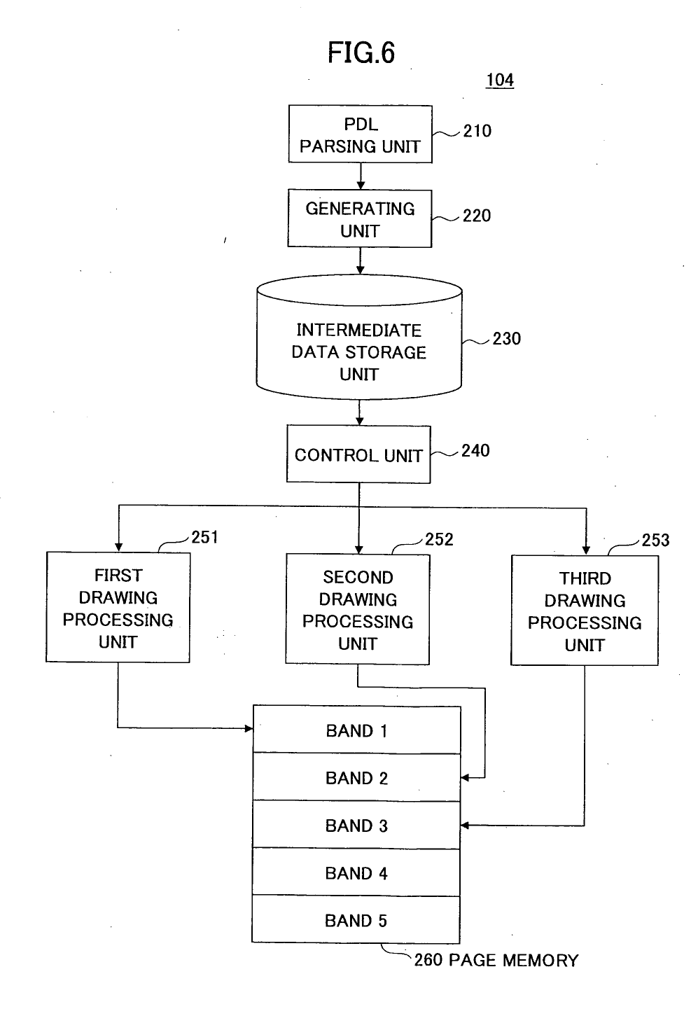

FIG. 6 is a functional block diagram of the image processing unit 104 according to the present embodiment. As illustrated, the image processing unit 104 includes a PDL parsing unit 210, a generating unit 220, an intermediate data storage unit 230, a control unit 240, drawing processing units 251 through 253, and a page memory 260. The number of the drawing processing units is not limited to three. Preferably, four or more drawing processing units may be used.

The PDL parsing unit 210 acquires the print information described in PDL, for example, and converts the print information into data of a format that can be processed by the generating unit 220 in order to generate a display list. The generating unit 220 generates the display list based on the data obtained by conversion by the PDL parsing unit 210, and stores the generated display list in the intermediate data storage unit 230.

The minimum unit of divided image data (raster image) is referred to as a “band”. The generating unit 220 may generate one or more display lists for each band. The display list may indicate (or include) one or more drawing instructions (commands) for generating image data. In the present embodiment, one display list is generated for each band, and the display list may include one or more of drawing instructions.

The drawing processing units 251 through 253 are associated with respective bands. Specifically, the drawing processing units 251 through 253 perform processes in accordance with the drawing instructions in the corresponding display lists, thus generating image data for the corresponding band.

In the example of FIG. 6, the first drawing processing unit. 251 processes the drawing instructions in the display list for band 1, and stores the resultant image data for band 1 in the memory 260. The second drawing processing unit 252 processes the drawing instructions in the display list for band 2, and stores the resultant image data for band 2 in the memory 260. Similarly, the third drawing processing unit 253 processes the drawing instructions in the display list of band 3, and stores the resultant image data for band 3 in the memory 260. When all of the drawing instructions in a display list are processed by the corresponding drawing processing unit, the display list is deleted.

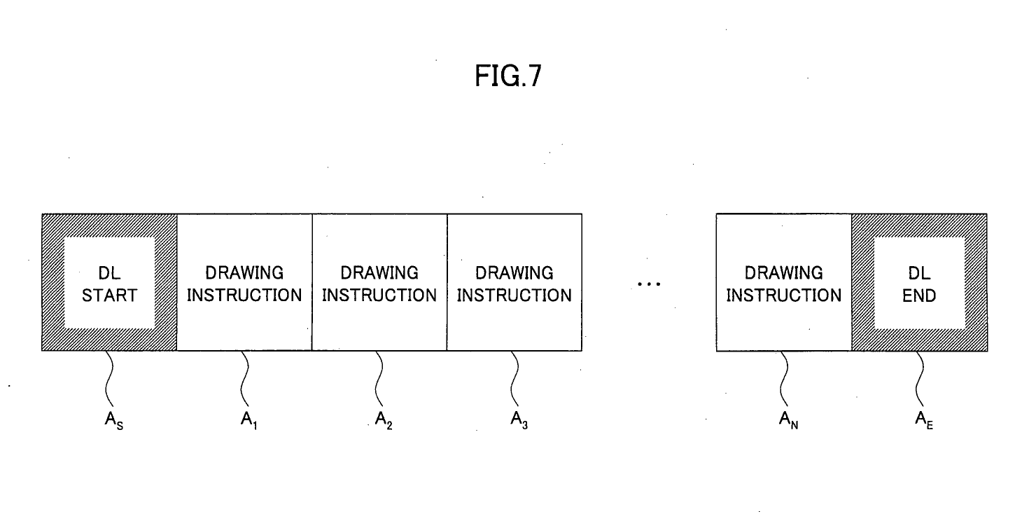

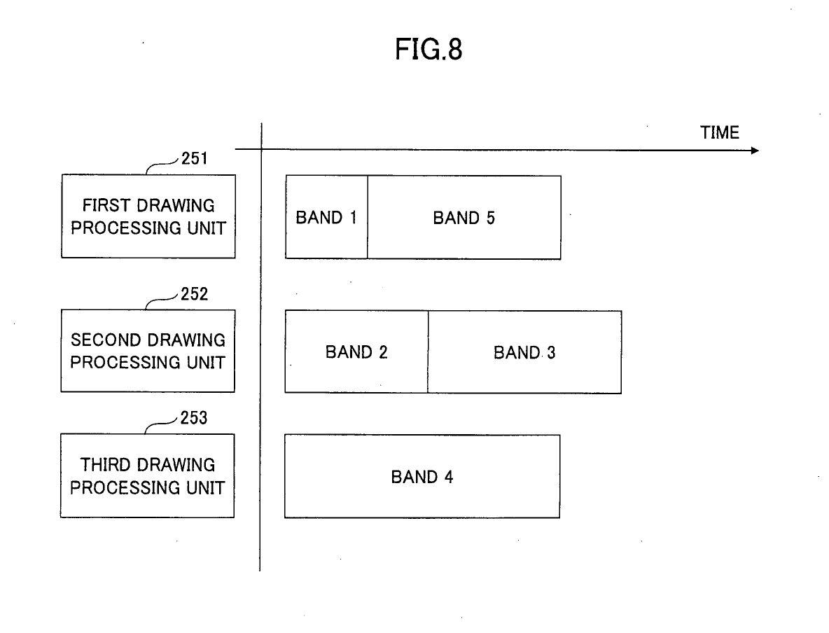

FIG. 7 illustrates a process of generating a display list. First, the generating unit 220 generates a DL start command Aₛ and stores the DL start command Aₛ in the intermediate data storage unit 230. The generating unit 220 then generates a number N of drawing instructions A₁ through A_{N} in order, and stores them in the intermediate data storage unit 230. The generating unit 220 finally generates a DL end command A_{E} and stores it in the intermediate data storage unit 230.

### <Drawing Processing Units>

The drawing processing units are described. By optionally adding a new drawing processing unit from the outside, the number of the drawing processing units can be increased. The drawing processing units may be divided into those for software control and those for hardware control. In such a case, the drawing processing units may have different attributes. The drawing processing unit that is added from the outside may include a hardware accelerator. The hardware accelerator may be inserted into a slot on a computer motherboard via a PCI interface.

The attribute of the drawing processing unit may indicate a processing capacity level with respect to a drawing instruction. Namely, when the drawing processing units have different attributes, the drawing processing units may have different processing capacity levels with respect to a drawing instruction. The processing capacity level may be indicated by numerical information, or relative information such as “high”, “low”, or “normal”. The processing capacity level for a drawing instruction may refer to a “processing capacity level for drawing according to a drawing instruction” or a “processing capacity level for a type of drawing according to a drawing instruction”.

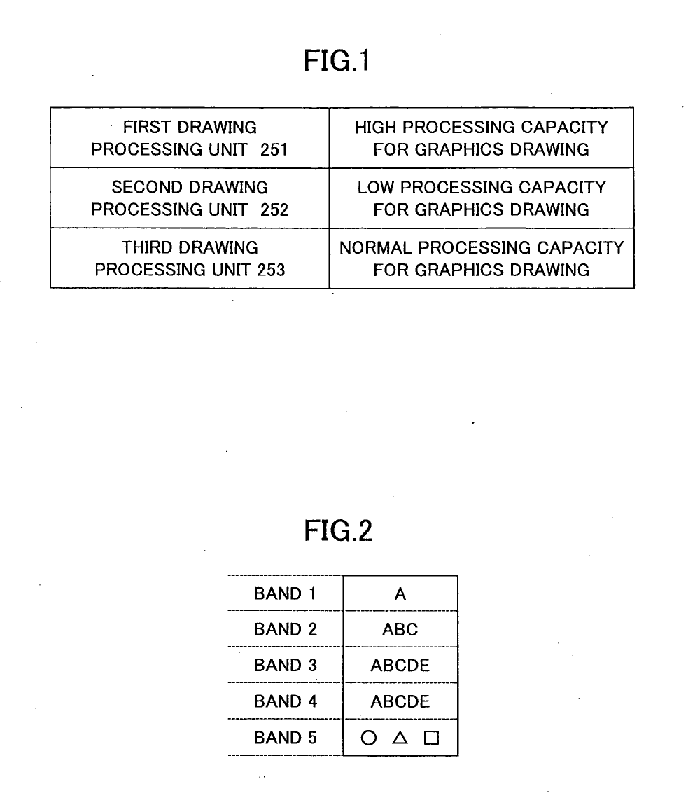

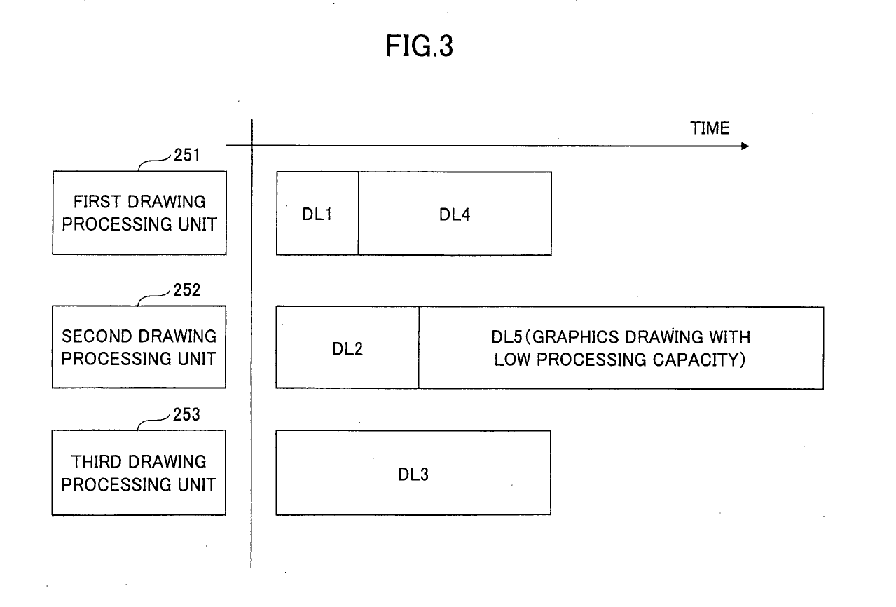

FIG. 1 illustrates an example of processing capacity levels of the first through third drawing processing units 251 through 253 for a type of drawing according to a drawing instruction. In the example of FIG. 1, the type of drawing according to the drawing instruction is graphics drawing. The first drawing processing unit 251 has a high processing capacity level for graphics drawing. The second drawing processing unit 252 has a low processing capacity level for graphics drawing. The third drawing processing unit 253 has a normal processing capacity level for graphics drawing.

The processing capacity level is described. The processing capacity levels of the drawing processing units are determined in advance. The processing capacity level may indicate the degree of processing capacity with respect to a drawing instruction in values. The processing capacity level may be determined by the time (“process time”) it takes for the drawing processing unit to perform processing in response to a given drawing instruction. Thus, the shorter the process time, the higher the processing capacity level may be. The longer the process time, the lower the processing capacity level may be.

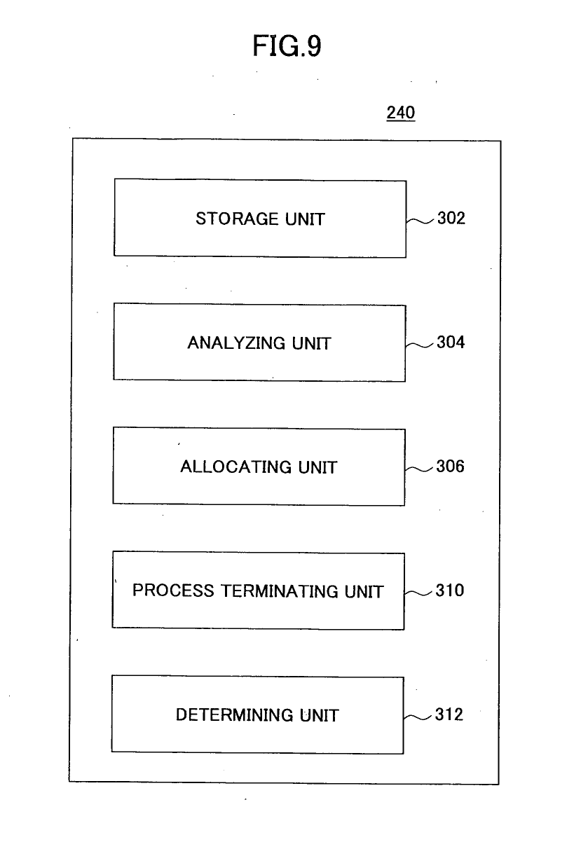

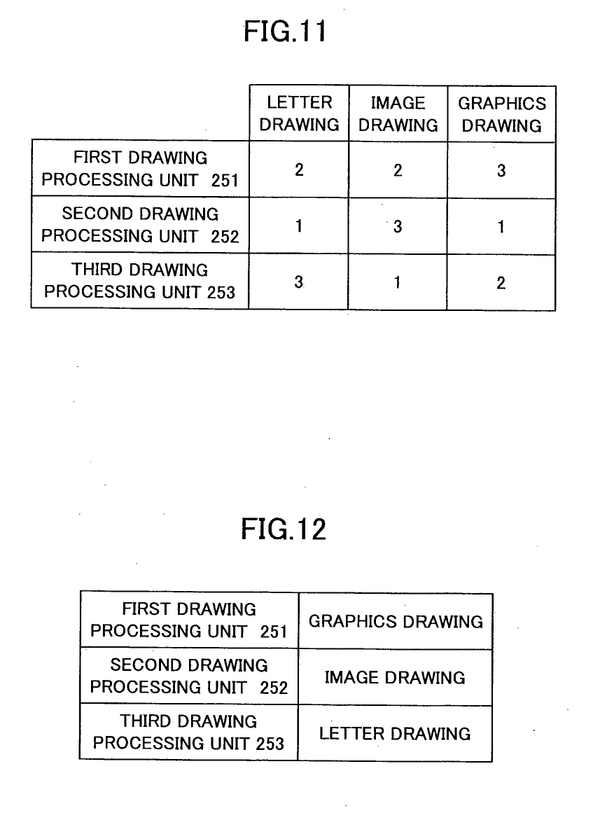

FIG. 9 illustrates a functional configuration of the control unit 240. In accordance with the present embodiment, the attributes of the first through third drawing processing units 251 through 253 are stored in a storage unit 302 in advance. Information that relates the drawing processing units to their attributes are referred to as “attribute information”. FIG. 11 illustrates an example of the attribute information where the attribute indicates a processing capacity level. In the example of FIG. 11, the processing capacity level of the drawing processing units is determined for different types of drawing according to the drawing instruction. In other words, the first through third drawing processing units 251 through 253 are associated with processing capacity levels for different types of drawing according to the drawing instruction. In the example of FIG. 11, the larger the value, the higher the processing capacity level. For example, as regards the first drawing processing unit 251, the processing capacity level for graphics drawing is “3”, which indicates a high processing capacity level. Thus, the first drawing processing unit 251 has a high processing capacity level for graphics drawing. In other words, the first drawing processing unit 251 is suitable for graphics drawing.

The attribute information may be expressed in a table format, as in the example of FIG. 11, or in a structured document such as XML format. In the example of FIG. 11, all of the drawing processing units are associated with processing capacity levels.

FIG. 12 illustrates another example of the attribute information. In this example, the drawing processing units are associated with a type of drawing for which the drawing processing units have a high processing capacity level. For example, the first drawing unit 251 has a high processing capacity level for graphics drawing.

The attribute information illustrated in FIG. 11 or FIG. 12 may be stored in the storage unit 302 of the control unit 240 illustrated FIG. 9. While FIGS. 11 and 12 illustrate the attribute information of all three of the drawing processing units, the attribute information may be determined for at least two of the drawing processing units when those two drawing processing units have different attributes.

In accordance with the present embodiment, the control unit 240 allocates the drawing instructions from the display list to the drawing processing units depending on their processing capacity. Namely, the control unit 240 allocates a particular drawing instruction from the display list to a specific drawing processing unit having a high processing capacity for drawing according to the particular drawing instruction so that the particular drawing instruction can be processed by the specific drawing processing unit.

### <Process Flow>

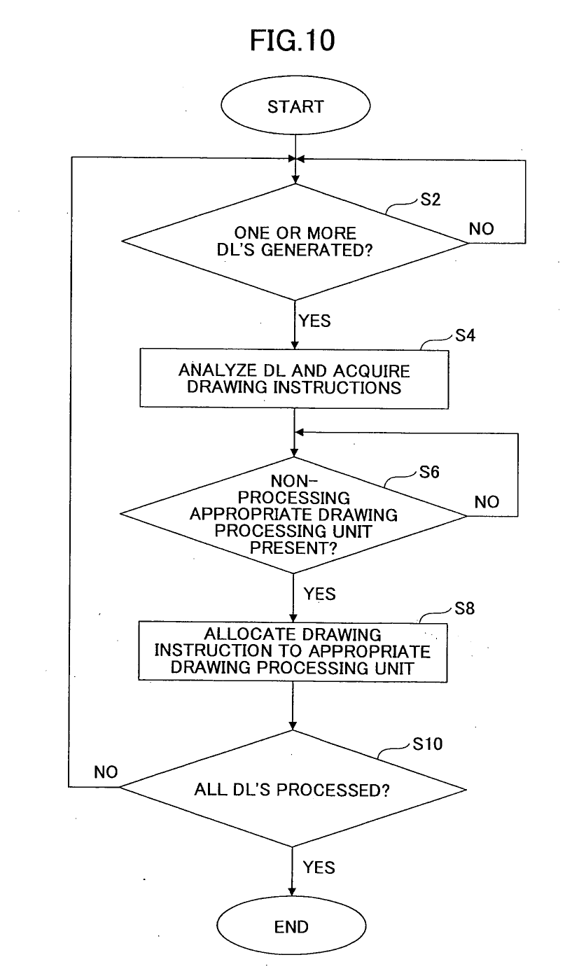

FIG. 10 is a flowchart of a process performed by the image forming apparatus 1 according to the present embodiment. In the following, a drawing processing unit that is not processing a drawing instruction may be referred to as a “non-processing drawing processing unit”, and a drawing processing unit that is processing a drawing instruction may be referred to as a “processing drawing processing unit”. A drawing processing unit having a high processing capacity level for a particular type of drawing according to the drawing instruction in a DL may be referred to as an “appropriate drawing processing unit” for the DL. A drawing processing unit with a low processing capacity level for a type of drawing according to the drawing instruction in the DL may be referred to as a “non-appropriate drawing processing unit” for the DL.

First, the analyzing unit 304 determines whether one or more DLs have been generated (step S2). The determination may be based on whether the DL end command A_{E} (see FIG. 7) is stored in the intermediate data storage unit 230. If the DL end command A_{E} is stored in the intermediate data storage unit 230, it may be determined that the generation of a DL is completed. If not, it may be determined that the generation of a DL is not completed.

When it is determined that no DL is generated (“No” in step S2), the process waits until at least one DL is generated. When it is determined that one or more DLs have been generated (“Yes” in step S2), the process moves to the next step S4.

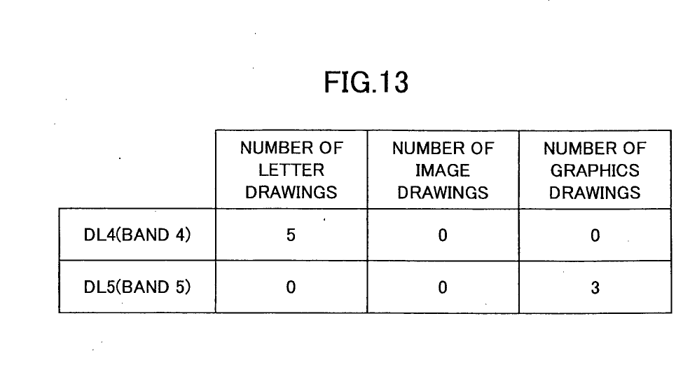

In step S4, the analyzing unit 304 analyzes the display list and acquires a drawing instruction contained in the display list (step S4). In the following, a method of analysis by the analyzing unit 304 is described, wherein the bands 1 through 5 illustrated in FIG. 2 are referred to as DLs 1 through 5, respectively. The analyzing unit 304 counts the number of drawing instructions contained in the display lists on a type by type basis. FIG. 13 illustrates a result of analysis of the display lists DL4 (band 4) and DL5 (band 5) by the result analyzing unit 304.

In the example of FIG. 13, DL4 (band 4) includes drawing instructions for drawing five letters, as illustrated in FIG. 2. DL5 (band 5) includes drawing instructions for drawing three graphics.

Then, the allocating unit 306 searches for a non-processing appropriate drawing processing unit for the DLs analyzed by the analyzing unit 304 in step S4 (step S6). The non-processing appropriate drawing processing unit is a drawing processing unit that is not processing and which is appropriate for the DL.

A method of searching for the non-processing appropriate drawing processing unit is described. When the number of the drawing instructions counted by the analyzing unit 304 for each type (of drawing) is equal to or larger than a predetermined threshold value β, the number of drawings according to the drawing instruction is said to be “large”. For example, when the threshold value β is “2”, the number of “letter drawings” according to the drawing instructions in DL4 is large. Also, the number of “graphics drawings” according to the drawing instructions of DL5 is large.

In the example of FIG. 11 (or FIG. 12) and FIG. 13, the number of letter drawings according to the drawing instructions of DL4 is “5”. Thus, the third drawing processing unit 253 with the high processing capacity for letter drawing may be suitably used for processing DL4 having the drawing instructions for a large number of letter drawings. Thus, the third drawing processing unit 253 is selected as the appropriate drawing processing unit for DL4.

The number of graphics drawings in DL5 is “3”. Thus, the first drawing processing unit 251 with the high processing capacity for graphics drawing may be preferably used for processing DL5 that includes the drawing instructions for a large number of graphics drawings. Thus, the first drawing processing unit 251 is selected as the appropriate drawing processing unit for DL5.

Thus, the allocating unit 306 searches for an appropriate drawing processing unit based on the number of drawings counted by the analyzing unit 304 for each type of drawing and the processing capacity level according to the processing capacity information. Specifically, the drawing processing unit with a high processing capacity level for a number of drawing instructions exceeding the threshold value β is selected as the appropriate drawing processing unit for the DL including the drawing instructions. When the appropriate drawing processing unit is not processing, the appropriate drawing processing unit is referred to as a non-processing appropriate drawing processing unit. The allocating unit 306 performs a search for such a non-processing appropriate drawing processing unit.

If the non-processing appropriate drawing processing unit does not exist (“No” in step S6), the process waits until a non-processing appropriate drawing processing unit appears. If the non-processing appropriate drawing processing unit exists, the process moves onto step S8.

In step S8, the allocating unit 306 causes the non-processing appropriate drawing processing unit to process at least the drawing instruction acquired by the analyzing unit 304 in step S4. The “at least the drawing instruction acquired by the analyzing unit 304 in step S4” may include all of the drawing instructions in the DL that includes the drawing instruction acquired by the analyzing unit 304 in step S4. In other words, when the number of the drawing instructions counted by the analyzing unit 304 is equal to or more than the threshold value β, the allocating unit 306 causes the appropriate drawing processing unit to process the drawing instruction (or all of the drawing instructions in the DL including the drawing instruction).

In the foregoing example, the allocating unit 306 causes the third drawing processing unit 253 to process the drawing instructions contained in DL4 and the first drawing processing unit 251 to process the drawing instructions contained in DL5.

The above method used by the allocating unit 306 to search for the non-processing appropriate drawing processing unit is merely an example, and other methods may be used. After the allocating process by the allocating unit 306 is completed, the process moves onto step S10. In step S10, the control unit 240 determines whether the drawing instructions of all of the DLs have been processed.

When the control unit 240 determines that not all of the drawing instructions of the DLs have been processed (“No” in step S10), the process returns to step S2 and the process from steps S2 through S10 is repeated until the drawing instructions of all of the DLs are processed. When all of the DLs are processed, the process ends (“Yes” in step S10).

Thus, in the image forming apparatus 1 according to the present embodiment, the analyzing unit 304 analyzes the generated DL and acquires a drawing instruction. Then, the drawing instruction contained in the analyzed display list, or all of the drawing instructions in the display list, are processed by the drawing processing unit with a high processing capacity for the drawing instruction. Thus, in accordance with Embodiment 1, when drawing processing units have different attributes with respect to a drawing instruction, the drawing instruction can be allocated to the drawing processing unit having a high processing capacity for the particular drawing instruction. Thus, the capacity of the individual drawing processing units can be fully utilized, thereby improving processing efficiency.

### Embodiment 2

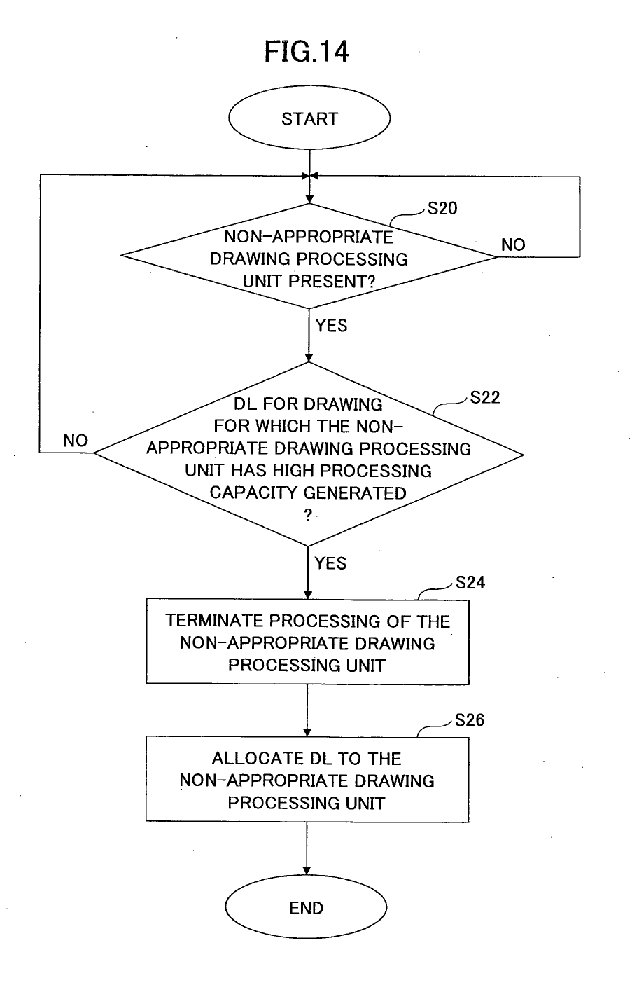

FIG. 14 is a flowchart of a process performed by the image forming apparatus 1 according to a second embodiment. In the following description, a “first drawing instruction” refers to a drawing instruction for which a drawing processing unit has a high processing capacity level. A “second drawing instruction” refers to a drawing instruction for which the drawing processing unit has a low processing capacity level. In the example of FIG. 11, the first drawing instruction for the first drawing processing unit 251 is the drawing instruction for graphics drawing. The second drawing instruction for the third drawing processing unit 253 is the drawing instruction for image drawing. The DL that includes the first drawing instruction is referred to as a “first DL”. The DL that includes the second drawing instruction is referred to as a “second DL”. As described with reference to Embodiment 1, the allocating unit 306 causes the first drawing instruction to be processed by an appropriate drawing processing unit (by allocating the first drawing instruction to the appropriate drawing processing unit).

Normally, a drawing processing unit (“first drawing processing unit”) to which the first drawing instruction is not allocated by the allocating unit 306 may be processing another drawing instruction (“second drawing instruction”). In this case, the first drawing processing unit is a non-appropriate drawing processing unit.

Namely, in this case, the first drawing processing unit is not allocated the drawing instruction for which the first drawing processing unit has a high processing capacity level (first drawing instruction), but is instead processing a drawing instruction (second drawing instruction) for which the first drawing processing unit has a low processing capacity level.

While the first drawing processing unit is processing the second drawing instruction, a DL1 may be generated that includes the first drawing instruction. In this case, the allocating unit 306 may preferably cause the first drawing processing unit to process a drawing instruction included in DL1 with high processing efficiency. However, the first drawing processing unit is processing the second drawing instruction with low processing efficiency. Thus, the allocating unit 306 interrupts the processing of the second drawing instruction with low processing efficiency, and causes the first drawing processing unit to process the drawing instruction included in DL1 with high processing efficiency. In this way, the overall processing efficiency can be further improved.

Further, in the example of FIG. 11, when the first drawing processing unit corresponds to the second drawing processing unit 252, the first drawing instruction is a drawing instruction for image drawing, while the second drawing instruction is a drawing instruction for graphics drawing and letter drawing. With reference to this example, a process flow of the image forming apparatus 1 according to Embodiment 2 is described.

FIG. 14 is a flowchart of the process flow according to Embodiment 2. First, the determining unit 312 determines whether the non-appropriate drawing processing unit is present (step S20). When the determining unit 312 determines that the non-appropriate drawing processing unit is present, the process moves onto step S22.

Then, the determining unit 312 determines whether the first DL that includes the drawing instruction (first drawing instruction) for which the non-appropriate drawing processing unit (the second drawing processing unit 252) has high processing capacity (such as image drawing) is generated by the generating unit 220 (step S22). When the first DL is not generated (“No” in step S22), the process returns to step S20.

When it is determined that the first DL is generated (“Yes” in step S22), the process goes on to step S24. In step S24, the process terminating unit 310 (see FIG. 9) interrupts the process of the second DL including the second drawing instruction (graphics drawing) that is currently being performed by the non-appropriate drawing processing unit (second drawing processing unit 252) (step S24).

Then, the allocating unit 306 allocates the first DL that includes the first drawing instruction (image drawing) for which the non-appropriate drawing processing unit has a high processing capacity to the non-appropriate drawing processing unit (second drawing processing unit 252)(step S26). In this way, the non-appropriate drawing processing unit, i.e., the second drawing processing unit 252, is turned into an appropriate drawing processing unit, whereby the processing efficiency can be further improved.

Normally, when the non-appropriate drawing processing unit is present for a long time, this means that the non-appropriate drawing processing unit is processing a drawing instruction for which the non-appropriate drawing processing unit has a low processing capacity for a long period, thus leading to reduced processing efficiency. In the image forming apparatus 1 according to Embodiment 2, when the drawing processing unit (non-appropriate drawing processing unit) to which no drawing instruction is allocated by the allocating unit 306 is processing a drawing instruction (“Yes” in step S20), the process being performed by the non-appropriate drawing processing unit is terminated upon generation of a DL that includes a drawing instruction for which the non-appropriate drawing processing unit has a high processing capacity (“Yes” in step S22). Then, the allocating unit 306 causes the non-appropriate drawing processing unit to process the DL that includes the drawing instruction for which the non-appropriate drawing processing unit has a high processing capacity. Thus, the time period in which the non-appropriate drawing processing unit is present can be reduced, while the non-appropriate drawing processing unit can process a drawing instruction for which the non-appropriate drawing processing unit has a high processing capacity, whereby improved processing efficiency can be achieved.

In step S24, the processing of the second drawing instruction by the non-appropriate drawing processing unit is interrupted. In the above example, the processing of graphics drawing by the second drawing processing unit 252 is interrupted. Thus, the process of the remaining drawing instructions in the second DL that includes the interrupted second drawing instruction (graphics drawing) is performed by another drawing processing unit (such as the drawing processing unit 251) with a high processing capacity for the remaining drawing instructions. In this way, the processing efficiency can be further improved.

### Embodiment 3

In Embodiment 1, the allocating unit 306 causes the non-processing appropriate drawing processing unit (appropriate drawing processing unit that is not processing) to process the drawing instructions in a specific DL. While the appropriate drawing processing unit is processing the first drawing instruction (first DL), another first DL may be generated that includes a first drawing instruction (another first drawing instruction) other than the first drawing instruction being processed. In such a case, the other first DL may be preferably allocated to the appropriate drawing processing unit. In this way, the appropriate drawing processing unit, after completing the processing of the earlier first DL, can process the subsequently allocated first DL. Thus, the appropriate drawing processing unit can process the first drawing instruction at all times, so that an improved processing efficiency can be achieved.

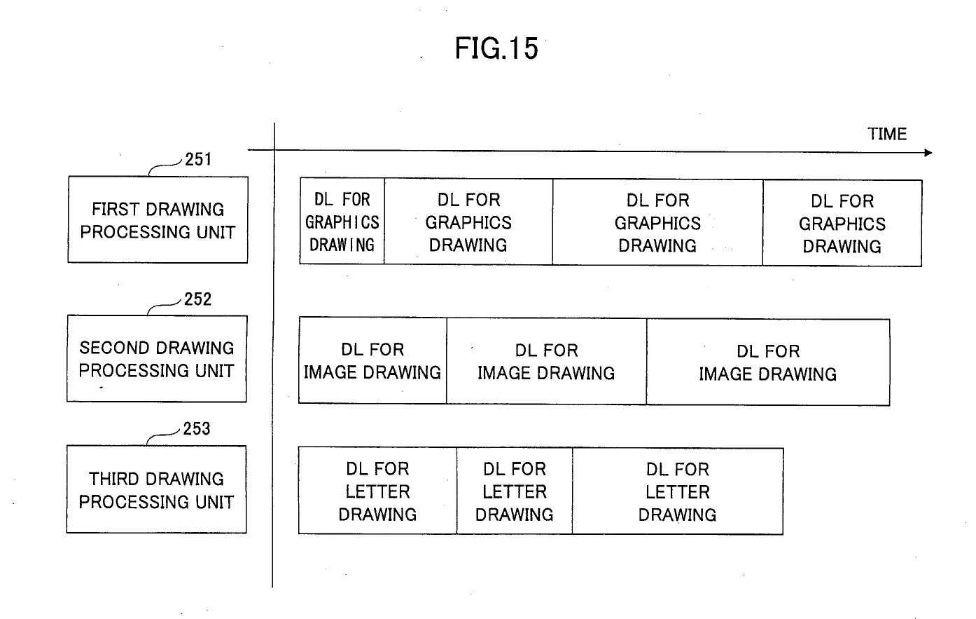

FIG. 15 illustrates processes performed by the drawing processing units 251 through 253 of the image forming apparatus 1 according to Embodiment 3. In the examples of FIGS. 11 and 12, the first drawing processing unit 251, for example, has a high processing capacity level for DLs including a number of graphics drawings. Thus, the first through third drawing processing units 251 through 253 are caused to process only those DLs including drawing instructions for which the drawing processing units have high processing capacity individually in accordance with Embodiment 3, as illustrated in FIG. 15. In this way, the processing efficiency can be further improved.

Although this invention has been described in detail with reference to certain embodiments, variations and modifications exist within the scope and spirit of the invention as described and defined in the following claims.

The present application is based on Japanese Priority Application No. 2010-204143 filed Sep. 13, 2010, the entire contents of which are hereby incorporated by reference.

What is claimed is:

1. An image forming apparatus comprising:
a plurality of drawing processing units configured to process one or more drawing instructions included in a display list, at least two of the plurality of drawing processing units having different attributes with respect to a first drawing instruction;
an analyzing unit configured to acquire the first drawing instruction by analyzing the display list; and
an allocating unit configured to allocate at least the first drawing instruction acquired by the analyzing unit to a first one of the drawing processing units based on the attributes of the at least two drawing processing units with respect to the first drawing instruction.

2. The image forming apparatus according to claim 1, wherein the attributes include a processing capacity level indicating a degree of processing capacity of the drawing processing units.

3. The image forming apparatus according to claim 2, wherein the processing capacity level is determined by a time it takes for the drawing processing units to process the drawing instructions.

4. The image forming apparatus according to claim 1, wherein the analyzing unit counts the number of a plurality of the drawing instructions included in the display list, and
wherein the allocating unit causes one of the plurality of drawing processing units to process at least the drawing instructions counted by the analyzing unit based on the number of the drawing instructions counted by the analyzing unit and the attributes.

5. The image forming apparatus according to claim 1, further comprising a process terminating unit,
wherein, when a second one of the drawing processing units to which the first drawing instruction is not allocated by the allocating unit is processing a second drawing instruction different from the first drawing instruction, the process terminating unit is configured to terminate processing of the second drawing instruction by the second drawing processing unit when the allocating unit allocates the first drawing instruction to the second drawing processing unit.

6. The image forming apparatus according to claim 5, wherein the allocating unit causes another one of the drawing processing units which is different from the second drawing processing unit to process the remaining drawing instructions in the display list that includes the second drawing instruction that is terminated by the terminating unit.

7. The image forming apparatus according to claim 1, wherein, when the first drawing processing unit is processing the first drawing instruction, the allocating unit allocates another drawing instruction to the first drawing processing unit,
wherein the first drawing processing unit processes the other drawing instruction allocated to the first drawing processing unit by the allocating unit after completing the processing of the first drawing instruction.

8. An image forming method for forming an image by using a plurality of drawing processing units configured to process one or more drawing instructions included in a display list, at least two of the plurality of drawing processing units having different attributes with respect to a first drawing instruction,
the image forming method comprising:
an analyzing step of acquiring the first drawing instruction by analyzing the display list; and
an allocating step of allocating at least the first drawing instruction acquired in the analyzing step to a first one of the drawing processing units based on the attributes of the at least two drawing processing units with respect to the first drawing instruction.

9. The image forming method according to claim 8, wherein the attributes include a processing capacity level indicating a degree of processing capacity of the drawing processing units.

10. The image forming method according to claim 9, wherein the processing capacity level is determined by a time it takes for the drawing processing units to process the drawing instructions.

11. The image forming method according to claim 8, wherein the analyzing step includes counting the number of a plurality of the drawing instructions included in the display list, and
wherein the allocating step includes causing one of the plurality of drawing processing units to process at least the drawing instructions counted in the analyzing step based on the number of the drawing instructions counted in the analyzing step and the attributes.

12. The image forming method according to claim 8, further comprising a process terminating step,
wherein, when a second one of the drawing processing units to which the first drawing instruction is not allocated in the allocating step is processing a second drawing instruction different from the first drawing instruction, the process terminating step includes terminating processing of the second drawing instruction in the second drawing processing step when the allocating step allocates the first drawing instruction to the second drawing processing unit.

13. The image forming method according to claim 12, wherein the allocating step includes causing another one of the drawing processing units which is different from the second drawing processing unit to process the remaining drawing instructions in the display list that includes the second drawing instruction that is terminated in the terminating step.

14. The image forming method according to claim 8, wherein, when the first drawing processing unit is processing the first drawing instruction, the allocating step includes allocating another drawing instruction to the first drawing processing unit,
wherein the first drawing processing unit processes the other drawing instruction allocated to the first drawing processing unit in the allocating step after completing the processing of the first drawing instruction.
